(19) United States
(12) Patent Application Publication
(10) Pub. No.: US 2014/0065910 A1
(43) Pub. Date: Mar. 6, 2014

(54) BOND SILICONE COATING

(71) Applicants: Hannes A. Alholm, Tolland, CT (US); Alan C. Barron, Jupiter, FL (US); Charles R. Watson, Windsor, CT (US); Jesse Meyer, Colchester, CT (US); Laura J. Dominick, Coventry, CT (US); William Blickenstaff, JR., Jupiter, FL (US); Christopher L. Dyer, Pomfret Center, CT (US); Brett Ennis, Glastonbury, CT (US); John H. Vontell, SR., Manchester, CT (US)

(72) Inventors: Hannes A. Alholm, Tolland, CT (US); Alan C. Barron, Jupiter, FL (US); Charles R. Watson, Windsor, CT (US); Jesse Meyer, Colchester, CT (US); Laura J. Dominick, Coventry, CT (US); William Blickenstaff, JR., Jupiter, FL (US); Christopher L. Dyer, Pomfret Center, CT (US); Brett Ennis, Glastonbury, CT (US); John H. Vontell, SR., Manchester, CT (US)

(73) Assignee: UNITED TECHNOLOGIES CORPORATION, Hartford, CT (US)

(21) Appl. No.: 13/600,366

(22) Filed: Aug. 31, 2012

(51) Int. Cl. B32B 27/12; B29C 45/14; B32B 17/02; B32B 5/02; B32B 25/20

(52) U.S. Cl. 442/180; 442/59; 428/221; 264/257; 156/245

(57) ABSTRACT

A silicone rubber coating material to be bonded to substrates such as on gas turbine components is made by providing a silicone rubber layer having a fiber layer attached to one side of the silicone rubber layer prior to its molding into a compound. The fibers may be either woven fabrics or random fiber sheets and the fiber layer may be from about 3 mils to about 30 mils (0.0762 mm to 0.762 mm) thick.

### STATEMENT OF GOVERNMENT INTEREST

This invention was made with government support under N00019-02-C-3003 awarded by the Navy. The government has certain rights in the invention.

### BACKGROUND

Silicone rubber elastomer is a polymer containing silicon along with carbon, hydrogen and oxygen. Silicone rubber may contain fillers to improve properties or reduce cost. Silicone rubber is found in a wide variety of products including the aerospace industry.

Silicone coatings subjected to temperatures up to and exceeding 500° F. are applied to external parts of gas turbine engines and aircraft frames using a spray process. Coatings applied using this method can degrade and disbond under extreme operating conditions.

Efforts are now being made to improve durability of silicone coatings subjected to temperatures up to and exceeding 500° F.

One area where silicone coatings have been employed is coating the exterior surface of an engine part or aircraft part. However, durability of these coatings has not been completely satisfactory due to the high operational temperatures.

Some silicone coatings have additional components, depending on the end use of the coatings. When a specific property is desired, such as thermal stability or electro-conductivity, for example, materials can be incorporated into the silicone prior to curing or molding.

### SUMMARY

The addition of a second layer to a silicone layer during molding promotes improved bonding to surfaces to which the molded silicone layer is secondarily bonded using an adhesive. Gas turbine engine parts and aircraft parts in general are coated with silicone coatings by secondarily bonding the silicone coatings with the second layer materially improving the adhesive bond. The second layer comprises woven fabric and/or a random fiber sheet such that the second layer resides at the surface of the molded silicone coating. Other materials in the interior of the silicone coating layer are present to achieve specific properties. The second layer of fiber reinforcing material may range from 3 mils to 30 mils (0.0762 mm to 0.762 mm) but is not limited to these thicknesses.

### BRIEF DESCRIPTION OF THE DRAWINGS

FIG. 1 is a schematic view of a tool used for molding silicone compounds.

FIG. 2 is a schematic view of a finished sheet according to this invention.

FIG. 3 is a schematic view of a substrate having a shape and adhesive thereon.

FIG. 4 is a schematic view of the finished sheet of FIG. 2 adhesively bonded to the substrate of FIG. 3.

### DETAILED DESCRIPTION

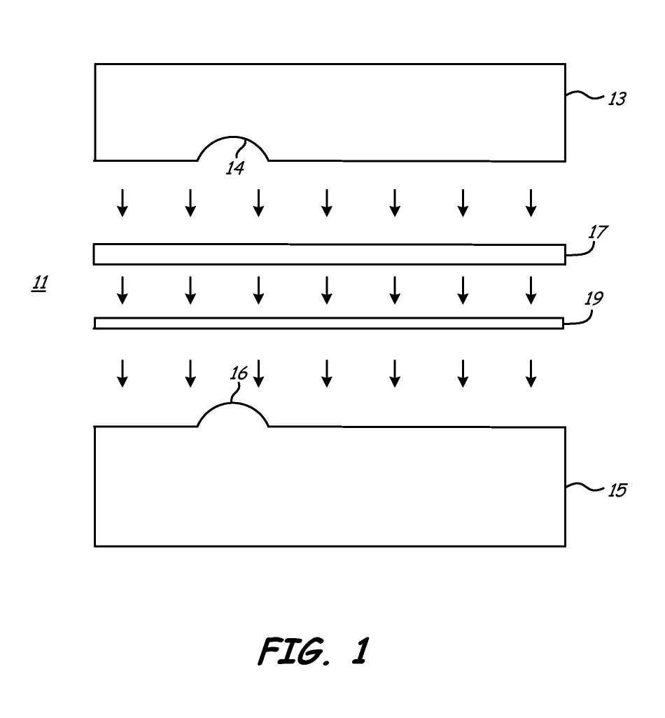

FIG. 1 represents a compression molding process 11 forming cured shapes of rubber material such as silicone rubber that can be secondarily bonded to a substrate such as an exterior surface of an engine or aircraft using the second layer. Alternate molding techniques such as injection and transfer can be used to mold the cured shapes, as can vacuum bag/oven molding. The molded shapes are designed to conform to the geometry of the engine component being coated. Either form of molding is used in this invention.

Upper compression mold die 13 and a lower or inner compression mold die 15 are designed to compression mold silicone rubber shape 17 incorporating second layer 19 in a conventional manner. Upper die 13 and lower die 15 are shown with recess 14 and raised portion 16 to illustrate a mold that conforms to the geometry of the substrate that will be covered by the silicone rubber, recognizing as noted above that much more complicated dies are used for more complicated geometries of the substrate.

Second layer 19 is placed on one side of silicone rubber sheet 17 prior to molding. All that is necessary in the molding process is to place second layer 19, formed of fiber, on the side of silicone rubber sheet 17. Alternately, the second layer 19 is formed with the geometry of the surface to be coated and inserted into the mold, followed by over molding with the silicone rubber.

Second layer 19 may contain polymers to assist in pre-forming the shape, temporarily tacking or positioning to either die 13 or 13 and/or improving bonding

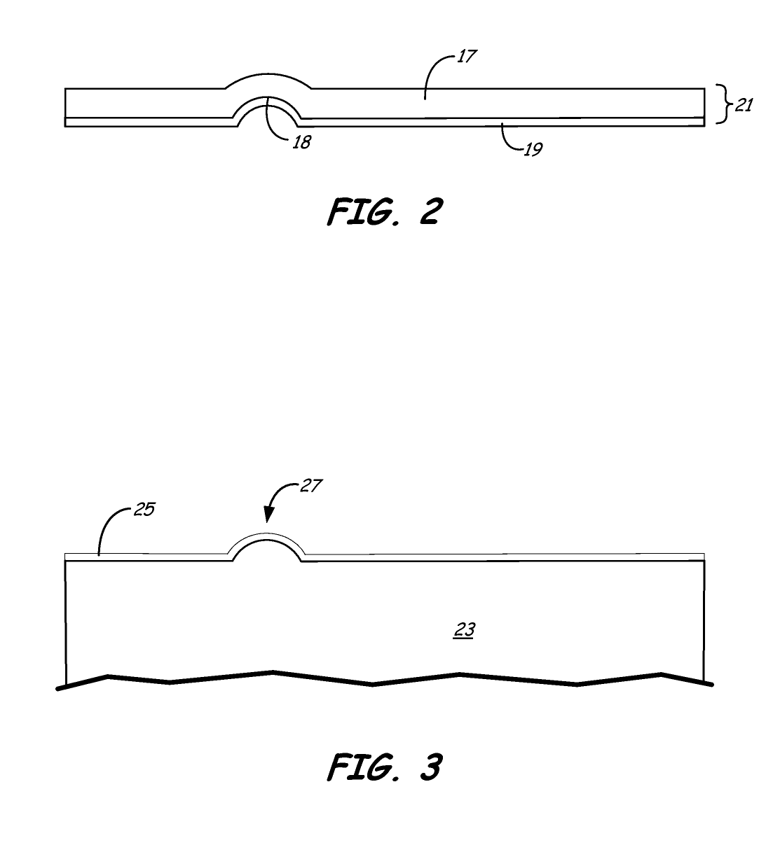

FIG. 2 represents such a molded sheet 21 having a silicon rubber layer 17 and a fibrous second layer 19 directly attached thereto. Second layer 19 may be any woven fabric or random fiber sheet, such as those made from fiber glass. Examples of suitable reinforcing fibers are: E-Glass, S-2 Glass, Graphite, Ceramics (including Alumina Borosilicate and Alumina Silicate), Carbon, Quartz (commercially available as Astroquartz) and Silicon Carbide. Molded sheet 21 includes a portion 18 that represents the geometry of the surface to be covered by it.

While the actual thickness of second layer 19 is to be determined by its intended use, thicknesses ranging from about 3 mils to about 30 mils (0.0762 mm to 0.762 mm) are typical.

FIG. 3 illustrates a substrate 23 that has an adhesive 25 thereon. Pattern 27 in the form of a projection is part of the geometry of substrate 23 that will be covered. Alternately, the adhesive can be applied to molded sheet 21

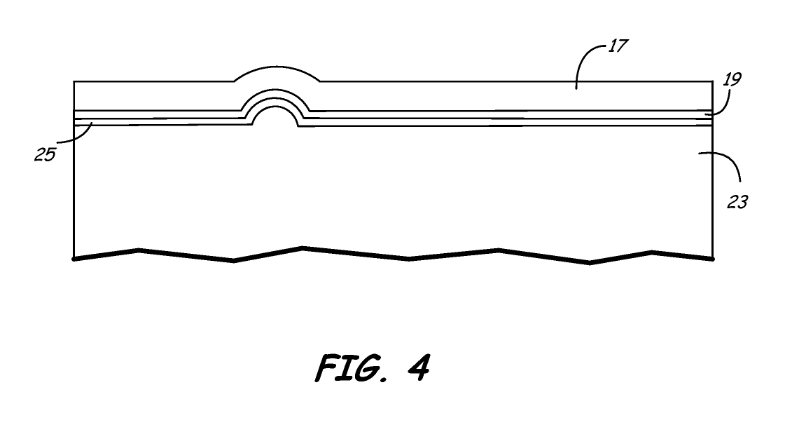

Sheet 21 is bonded to the substrate surface by bonding second layer 19 of molded sheet 21 on substrate surface 23 as seen in FIG. 4, rather than as has been done by bonding a silicone rubber layer 17 without any second layer. Sheet 21 is applied to surface 23 by way of uncured polymeric film adhesive 25, such as, for example, a silicone film. Adhesive 25 is cured during a secondary bonding process, typically using an autoclave to produce the final bonded coating assembly. Improved bonding is attained by the present invention when second layer 19 is bonded to substrate 23, such as gas turbine engines components. Fiber layer 19, which is partially embedded in the cured silicone rubber 17, bonds with uncured polymeric film adhesive 25, and is expected to yield a benefit in adhesive strength by way of mechanical interlocking, increased bond area and inclusion of a fiber whose bond strength to rubber 17 and adhesive 25 exceeds the bond strength of adhesive 25 to cured rubber 25.

Substrate 23 may be metal such as aluminum and titanium, polymer matrix fiber reinforced composite or ceramic matrix fiber reinforced composite. Substrate 23 may be treated with adhesion promoters.

As noted above, silicone rubber layer 17 may contain other components inside it, such as fillers that impart a specific property such as thermal or electrical conductivity to the silicone rubber. The substrate geometry and silicone rubber properties determines the shape of sheet 21 and molding technique.

As noted above, fiber layer 19 first formed to conform to the surface, then inserted into the mold, and silicone rubber layer 17 is introduced into the cavity to overmold it on to fiber layer 19.

Alternately, discontinuous fiber combined with a binder can be sprayed directly onto the die surface, accommodating complex geometries, followed by overmolding with silicone rubber layer 17.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A silicone rubber coating material comprising:
a first layer of molded silicone rubber compound; and
a second layer of fibers molded to one side of the first layer.

2. The material of claim 1, wherein the second layer is from about 3 mil to about 30 mil (0.0762 mm to 0.762 mm) thick.

3. The material of claim 1, wherein the second layer is selected from woven fabrics and random fiber sheets.

4. The material of claim 1, wherein the second layer comprises fiberglass.

5. The material of claim 1, wherein the first layer includes additional components for modifying the properties of the first layer.

6. The material of claim 1, wherein the second layer is adhesively bonded to a substrate such as aluminum and titanium metal, polymer matrix fiber reinforces composites and ceramic matrix fiber reinforced composites.

7. The material of claim 6, wherein the substrate is on an aircraft or gas turbine engine.

8. The material of claim 1, wherein the second layer is molded to the first layer by compression, transfer or injection molding and vacuum bag/oven or autoclave.

9. A method of making a silicone rubber material, the method comprising:
introducing silicone rubber compound into a mold; and
introducing a layer of fibers in the mold; and
molding the silicone rubber compound and the layer of fibers to form a composite sheet having the layer of fibers bonded to the silicone rubber compound and located at one surface of the composite sheet.

10. The method of claim 9, wherein the layer of fibers is from about 3 mil to about 30 mil (0.0762 mm to 0.762 mm) thick.

11. The method of claim 9, wherein the layer of fibers is selected from woven fabrics and random fiber sheets.

12. The method of claim 9, wherein the layer of fibers comprises fiberglass.

13. The method of claim 9, wherein the silicone rubber compound includes additional components for modifying the properties of the rubber compound.

14. The method of claim 9, wherein the composite sheet is bonded to a substrate surface by adhesively bonding the layer of fibers to the substrate surface.

15. The method of claim 14, wherein the substrate surface is on an aircraft or gas turbine engine.

16. A method of applying a silicone rubber coating material to a surface, the method comprising:
molding a silicone rubber compound and a fiber to produce a composite sheet having the fiber layer bonded to the silicone rubber compound and located at one surface of the composite sheet; and
bonding the composite sheet to a substrate surface by adhesive bonding between the substrate and the fiber layer.

17. The method of claim 16, wherein the fiber layer is from about 3 mil to about 30 mil (0.0762 mm to 0.762 mm) thick.

18. The method of claim 16, wherein the molding causes the composite sheet to conform to a geometry of the substrate surface

19. The method of claim 16, wherein the silicone rubber compound includes additional components for modifying the properties of the first layer.

20. The method of claim 16, wherein the fiber layer is bonded to a substrate surface by placing the second layer on the substrate surface with adhesive thereon and curing the adhesive.
